(19) United States
(12) Patent Application Publication
(10) Pub. No.: US 2015/0206300 A1
(43) Pub. Date: Jul. 23, 2015

(54) METHOD AND APPARATUS FOR EXTRACTION AND QUANTIFICATION OF HEMATOMA FROM A BRAIN SCAN SUCH AS COMPUTED TOMOGRAPHY DATA

(71) Applicant: Agency for Science, Technology and Research, Singapore (SG)

(72) Inventors: Wieslaw Lucjan NOWINSKI, Singapore (SG); Varsha GUPTA, Singapore (SG)

(21) Appl. No.: 14/160,489

(22) Filed: Jan. 21, 2014

(51) Int. Cl. G06T 7/00; G06K 9/46

(52) U.S. Cl. CPC G06T 7/0012; G06K 9/46; G06K 2009/4666

(57) ABSTRACT

A method is proposed for processing a CT brain scan to identify hematoma and extract data quantifying it. The method uses anatomical, pathological and imaging knowledge comprising (i) distribution data obtained from population studies and characterizing typical intensity distributions of one or more different types of material present in brains, one of the types of material being hematoma, (ii) at least one spatial template describing the spatial layout of a brain. Based on these, the method defines a respective volume of interest for each of a number of ventricles, and extracts data characterizing hematoma in the volume(s) of interest, which need not be hematoma within the ventricles. The distribution data describes typical intensity distributions of hematoma (clots), grey matter (GM), white matter (WM) and cerebrospinal fluid (CSF), and may be in Hounsfield Units (HU).

### FIELD OF THE INVENTION

The present invention relates to automatic, or semi-automatic, analysis of tomography scans, to extract information relating to a hemorrhagic stroke.

### BACKGROUND OF THE INVENTION

Various methods exist for the automatic segmentation of brain scan data, such as computed tomography (CT) scan data. For example, methods of automatically identifying haemorrhagic regions in brain scan data are disclosed in: Prakash et al, “A Method and System of Segmenting CT Scan Data”, Pub no. WO2009/110850 A1; Meetz et al, “Detecting Haemorrhagic Stroke in CT Image Data”, Pub no. US 2010/0183211 A1; and Wang et al, “Method and Apparatus for Cerebral Hemorrhage Segmentation”. Pub no. U.S. Pat. No. 8,340,384.

However, there is a need for methods which are more rapid, have greater accuracy, cope with high data variability, and/or which generate other data characterizing the brain scan data.

### SUMMARY OF THE INVENTION

The present invention aims to provide new and useful methods and systems for extracting data characterizing hemorrhagic strokes from brain scan data, such as one or more CT scans, and in particular one or more non-contrast computed tomography (NCCT) scans, that is a CT scan which has been generated without administering a contrast to the subject.

In general terms, the present invention proposes that a brain scan of a patient who has suffered a hemorrhagic stroke is analysed by:
using pre-defined data generated based on pre-existing anatomical, pathological and/or imaging knowledge, and comprising pre-defined distribution data describing one or more typical brain scan intensity distributions of hematoma and optionally one or more further respective types of material present in brains, to define, for one or more predefined regions of the brain, respective portion(s) of the brain scan; and
using the distribution data to identify hematoma in the one or more portion(s) of the brain scan.

The hematoma may be inside the ventricles (IVH) or outside the ventricles, such as ICH (intracerebral hematoma).

Preferably, one of the regions of the brain is the fourth ventricle, and in this case the respective portion of the brain is a volume of interest comprising the expected position of the fourth ventricle.

Preferably, the regions of the brain include the third ventricle and/or lateral ventricle, and in this case the respective portion of the brain may be a brain mask including expected positions of the third ventricle and/or lateral ventricle

The distribution data is data which has been generated based on a population of previous subjects. It may characterize typical intensity distributions of respective types of material present in the brain by, for example, indicating, for each type of material, the most common intensity of the voxels of a typical brain scan which represent that type of material. In other words, if, for a given type of material, we consider the voxels of a typical brain scan which represent that type of material, then the distribution data for that type of material may comprise the most common intensity of such voxels. That is, it for each of a number of intensity values, we plot a histogram of how many of those voxels have that intensity value, then the distribution data may indicate the intensity value for which the histogram has a peak.

Preferably, the distribution data includes respective distribution data describing the typical intensity distribution of, in addition to hematoma (clots), one of more of grey matter (GM), white matter (WM) and cerebrospinal fluid (CSF). The distribution data may express intensity in Hounsfield Units (HU).

The distribution data for hematoma may be available for each of a plurality of different times after a hemorrhage has occurred, and in this case the embodiment uses the distribution data for the one of these times which corresponds most closely to the time difference between when the patient suffered the hemorrhage and when the brain scan was captured.

Preferably, the pre-defined data further includes at least one spatial template describing the spatial layout of a brain. The spatial template may be a ventricular template, describing the spatial layout of the structures in the brain containing cerebrospinal fluid. In this case, the embodiment may exploit the known general extent of the ventricular system in selecting the one or more portions of the brain scan.

Advantageously, the embodiment does not require skull stripping.

Once the hematoma has been identified, this can be used to select a suitable course of treatment, which is then applied to the patient.

The embodiment may include generating a numerical measure of the amount of hemotoma present. In this case, a suitable course of treatment can be selected and applied based on the numerical measure.

This method is applicable to intraventricular hemorrhage (IVH) alone or IVH along with ICH (intracranial hemorrhage). It is suitable to process a single scan or multiple scans.

In one example, the embodiment may be used to process a series of scans taken at different respective times during a certain time period, and thereby monitoring treatment efficacy, for example to enable a treatment carried out on the patient during the time period to be modified.

The invention may be expressed as a method, as a computer system programmed to perform the method, or as a computer program product comprising program instructions (for example stored on a tangible non-transitory storage medium such as a diskette, hard drive or CD) operative when run by a processor to cause the processor to carry out the method.

In particular, it may be expressed as a method of treating a patient. In one example, the treatment method may include extracting the volume of hematoma, and using it to select a treatment step, for example from a pre-defined list of a plurality of treatment options. In another example, the treatment method may include extracting segmented hematoma, and using the extracted hematoma to guide stereotactic placement of a catheter.

### BRIEF DESCRIPTION OF THE FIGURES

An embodiment of the method will now be described for the sake of example only with reference to the following figures, in which:

FIG. 1 is a flowchart of a method which is an embodiment of the invention, for extraction and quantification of hematoma from NCCT.

FIG. 2 shows averaged and renormalized distributions of the radio-density of hematoma material in Hounsfield Units (HU), the distributions being derived from hematoma material which has been manually identified in the brain-scans of a population of subjects who have suffered a hemorrhagic stroke, where FIG. 2(a) is the distribution averaged over scans collected at differing numbers of days after the stroke, and FIG. 2(b) shows three distributions averaged over scans collected respectively 1 day, 3 days and d days after the hemorrhagic stroke.

FIG. 3 shows the sub-steps of step 3 of FIG. 1.

FIG. 4 is a plot which, for each of a number of axial slices of a patient's brain scan, shows the corresponding number of voxels having an intensity which is characteristic of CSF, WM, GM or hematoma.

FIG. 5, which is composed of FIGS. 5(a)-(e), shows axial slices of brain scans for respective patients with an axial position corresponding to the maximum in FIG. 4.

FIG. 6 is composed of FIG. 6(a), which shows, for each of a sequence of axial slices at respective positions in the axial direction, the number of voxels in a brain scan having an intensity typical of a skull, and FIGS. 6(b), 6(c) and 6(d) which show typical axial slices at three positions P1, P2 and P3 marked in FIG. 6(a).

FIG. 7 is composed of FIG. 7(a), which shows, for each of a sequence of cropped sagittal slices, at respective positions in the sagittal direction, the number of voxels having an intensity which is characteristic of CSF. WM, GM or hematoma, FIG. 7(b), is which shows, for each of a sequence of cropped coronal slices, at respective positions in the coronal direction, the number of voxels having an intensity which is characteristic of CSF, WM, GM or hematoma, and FIG. 7(c) which shows the position in an axial slice of a ROI having sagittal and coronal extents derived using the distributions shown in FIGS. 7(a) and 7(b).

FIG. 8 shows the sub-steps of step 4 of FIG. 1.

FIG. 9 shows an axial slice of the patient's brain scan, marking as white those voxels which fall between two thresholds L and R, and after small isolated regions have been excluded.

FIG. 10 is composed of FIG. 10(a) which, for a row of the thresholded brain scan shown in FIG. 9, plots the intensity of the brain scan in positions along the row, and FIG. 10(b) which shows the corresponding axial slice of the brain scan, the position of the row within this axial slice, and candidate hematoma voxels which are part of this row.

FIG. 11 is composed of FIG. 11(a) which shows an original axial slice of the brain scan. FIG. 11(b) which shows the slice obtained from it after seed generation, and FIG. 11(c) which shows ground truth hematoma voxels generated manually.

FIG. 12 shows sub-steps of a post-processing step of the method of FIG. 1.

FIG. 13 is composed of FIGS. 10(a)-(c), which are axial slices of NCCT images at different axial positions, and FIGS. 10(d)-(f) which are the corresponding final segmented images of a hemorrhage obtained by the method of FIG. 1.

### DETAILED DESCRIPTION OF THE EMBODIMENTS

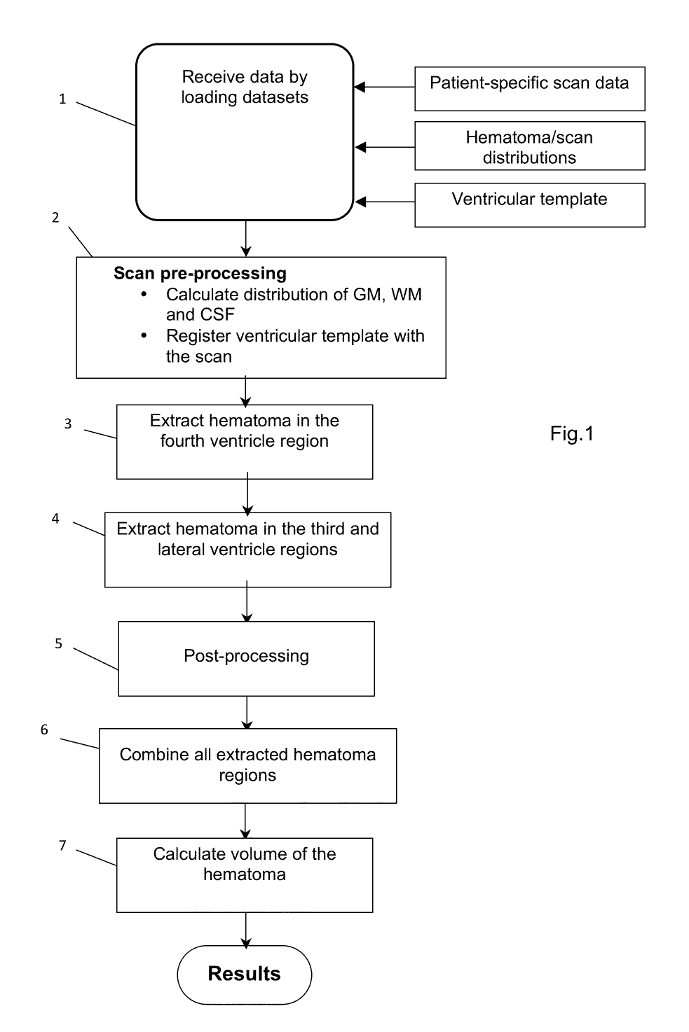

Referring firstly to FIG. 1, a flowchart is shown, showing the main steps of a method which is an embodiment of the method, for obtaining data characterizing hematoma in a person referred to below as the “patient”. The method may be initiated manually, but is preferably performed automatically, which means that each step of the method is performed without human involvement.

### Step 1: Receiving Data by Loading Datasets

A first step (step 1) of the method is to load the datasets used by the method. This includes one or more three-dimensional brain scans specific to the patient (“patient-specific scan data”), such as NCCT dataset(s). It further includes pre-defined datasets, obtained in advance using a corresponding set (“population”) of other human subjects.

A first type of pre-defined data obtained in step 1 is one or more pre-calculated distribution datasets, each characterizing how a corresponding type of material appears in a brain scan. One of more of the distribution datasets may be in Hounsfield Units (HU), which describe the degree to which the type of material attenuates X-rays passing through it (“radio-density”). Each distribution dataset is calculated using NCCT imaging scan data from the population of previous subjects, by manually marking regions of each of the scans in which the corresponding type of material is present (“ground truth”), and then finding the distribution of radio-density for those ground truth regions.

For example, the embodiment has access to one or more pre-calculated hematoma (clot) distribution datasets. Each hematoma distribution dataset is in Hounsfield Units (HU), and is determined from NCCT imaging based on ground truth clot regions marked on brain scans relating to a population of subjects who have suffered a hemorrhagic stroke.

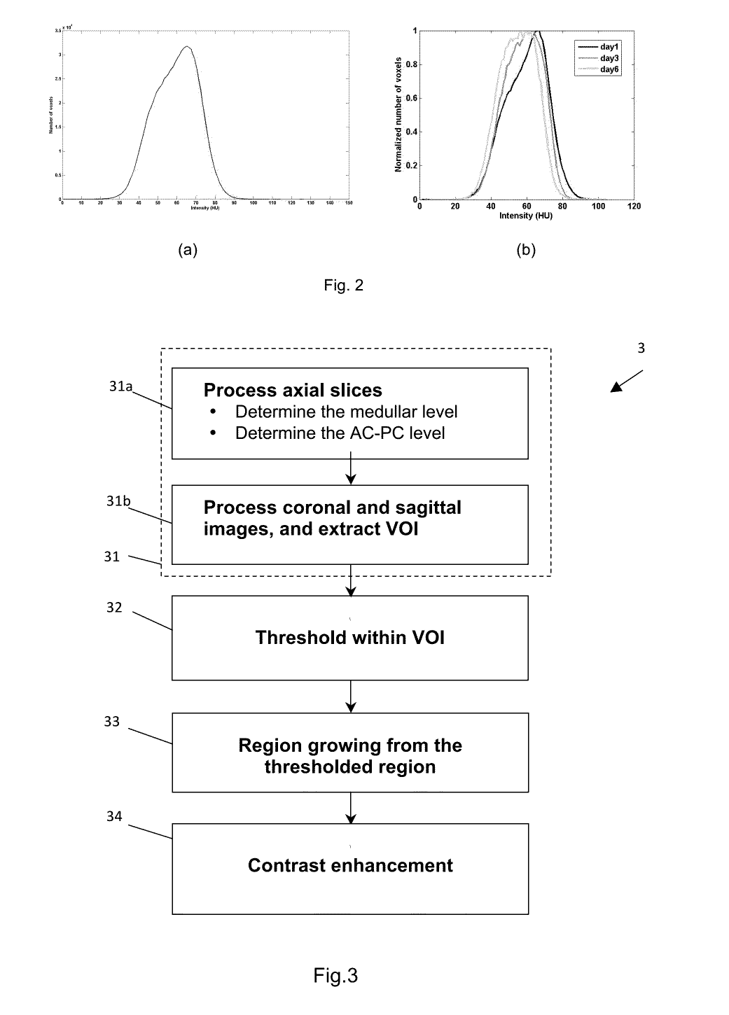

The method may use both a first pre-calculated hematoma distribution dataset which shows the overall HU distribution in scans collected from subjects at a number of different times after they have suffered a hemorrhagic stroke (as shown in FIG. 2(a)), and a plurality of time-specific hematoma distribution datasets which show the HU distribution in scans collected from subjects at respective specific times after they have suffered a hemorrhagic stroke (as shown in FIG. 2(b), where the three lines respectively show radio-density distributions of clot material in scans collected one day, three days and six days after the subject has suffered a hemorrhagic stroke).

Thus, if it is known how long ago the patient suffered a hemmorhagic stroke, the corresponding time-specific hematoma distribution dataset gives the expected range and median (mean) value of intensities of the clot regions, and the shapes of distribution.

Other distribution datasets used by the embodiment include distribution datasets for grey matter (GM), white matter (WM) and cerebrospinal fluid (CSF). The embodiment may further employ distribution datasets describing their ratios, their relationships to the hematoma distributions, and/or their distribution in function of energy, voltage and current. Any of these may be useful in setting the proper values of parameters used in the embodiment.

A second type of pre-defined data which may be obtained in step 1 is a ventricular template. The ventricular template provides the maximal extent of the ventricular system in the brain. It can be built in many ways. For instance, our template [1] can be employed. As described below, the ventricular template optionally can be used to provide spatial limits in thresholding and region growing operations. For instance, as also described below, the method may include region growing, and this can be restricted to the IVH by a spatial template, in particular, the ventricular template. As will further be described below, the ventricular template is individualized to the patient-specific scan by applying template-to-scan registration.

### Step 2 Scan Pre-Processing

The patient-specific scan is pre-processed before performing the hematoma extraction as follows. The mean and standard deviations of the intensities of GM, WM and CSF are extracted from the patient-specific scans. Any automatic and accurate method can be used to calculate these, in particular, our method presented in [2,3]. As explained below, these values of the mean and standard deviation of the intensity of CSF. WM and GM are used in extraction of Volumes of Interest around the fourth ventricle, third and lateral ventricles.

The ventricular template is co-registered with the patient's scan. Any procedure can be applied to do this registration; in particular that based on ellipse fitting presented in [4,5].

### Step 3 Extraction of Hematoma in the Fourth Ventricle Region

Artefacts which mimic hematoma are often present in the posterior fossa region. The major sources of segmentation artefacts in slices containing the fourth ventricle are because of non-brain tissues (such as the eyes and neck muscles). To address this, the embodiment proposes that a VOI is calculated encompassing the fourth ventricle based on anatomical knowledge and imaging characteristics, and then the hematoma is extracted in this VOI.

Specifically, hematoma is extracted in the fourth ventricle region in four sub-steps: extracting a three-dimensional region of Interest (i.e. a volume of interest, VOI) around the fourth ventricle (sub-step 31, which in turn is composed of sub-steps 31a and 31b); thresholding within the VOI based on hematoma distribution (sub-step 32); adaptive region growing (sub-step 33); and contrast enhancement (sub-step 34).

Sub-step 31 (VCI extraction) is performed using slices of the patient's brain scan in the axial, coronal, and sagittal planes, together with the clot and skull intensity (HU) distribution datasets. The VOI extraction is based on the distribution within the scan of material which constitutes the “brain-with-a-clot” (defined as the tissues having an intensity in the brain scan which corresponds to a radio-density in a range typical of CSF. WM, GM and hemorrhage, for instance ˜0-90 HU) and the skull (assumed to be the material with a radio-density in a suitable pre-determined range, for instance. >120 HU). These locations are found in two-dimensional images from the brain scan in axial, coronal and sagittal orientations (i.e. axial slices, coronal slices and sagittal slices of the brain scan), and used to generate distributions along axes in these directions, which are in turn used to detect further characteristics of the scan.

(i) Sub-Step 31a: Brain-with-a-Clot Voxels and Skull Voxels in Axial Slices

This step derives landmarks in the brain using the shape of the brain-with-a-clot and skull distributions along an axis in the axial direction.

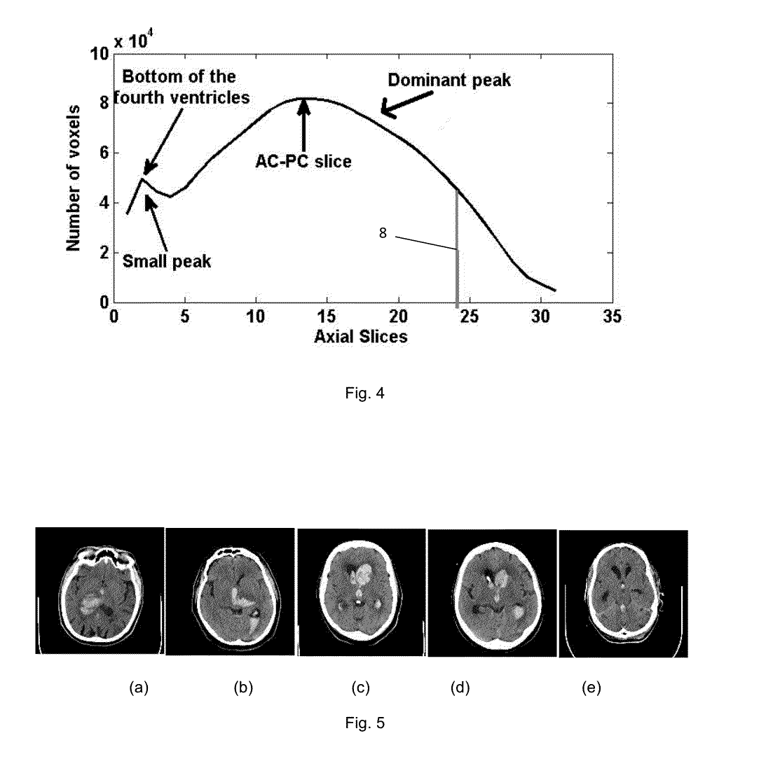

First, the total number of voxels which are CSF, WM, GM or hematoma (i.e. the brain-with-a-clot tissue) in each axial slice is plotted against the slice number, as shown in FIG. 4 for a typical patient. The left-to-right direction in FIG. 4 corresponds to the axial direction from the inferior to superior slices. A small peak is observed on the left, and a dominant peak is observed more centrally. Anatomically, the small peak represents the soft tissues in the skull base region in the intensity range of (CSF, WM, GM, hematoma), which may or may not be part of the brain (e.g., head muscles) and usually contribute to segmentation errors. Sub-step 31a includes identifying the small peak. This peak is at an axial position corresponding to the medulla (medullar region of the brainstem). Note that the small peak will be missing if the scan does not contain this region, and in this case sub-step 31a instead identifies the first slice of the scan.

The overall shape of the curve in FIG. 4 represents the number of tissue voxels (the brain-with-a-clot voxels) increasing and then decreasing. Anatomically, the slice with the maximum number of brain-with-a-clot voxels represents approximately the AC-PC (the anterior (AC) and posterior commissure (PC)) plane, depending on head tilt. By calculating the midsagittal plane (MSP) and reorienting the images to be perpendicular to the MSP, head tilt can be compensated, and this is preferably performed in step 3. A few slice examples corresponding to the maximum in the brain with a clot distribution are shown in FIG. 5.

The ventricular system ends superiorly, and this corresponds to a region where this plot in FIG. 4 decreases. For instance, as observed in the data, the slice at the half maximum (the line 8 in FIG. 4) of the brain-with-a-clot distribution plot (on the post-maximum side of the dominant peak in FIG. 4) can be considered to be above the ventricular region, i.e. it marks the superior end of the ventricles. This line 8 is found, and in the later steps of the method, the slices superior to this slice are ignored when the IVH is being analysed.

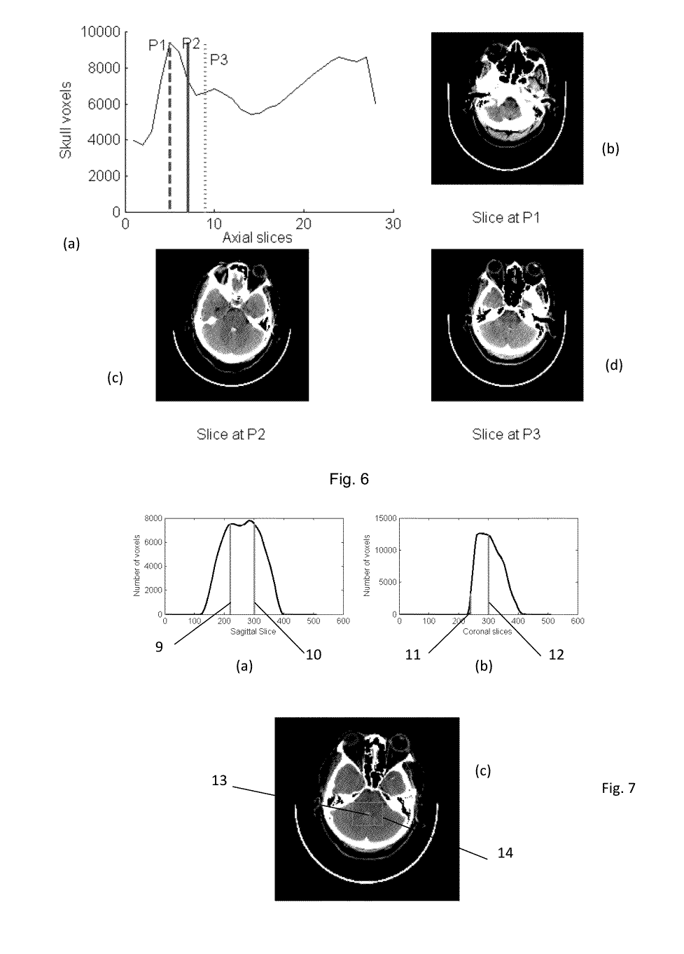

Likewise, the total number of skull voxels per axial slice is calculated (for instance, the voxels having a radio-density >120 HU) and plotted as a distribution over the axial slices. Typically, the result is as shown in FIG. 6(a). The distribution shows a peak region in the inferior slices which corresponds to the skull base, with an almost constant value for middle slices, and then the fall in the distribution. This is the region where the fourth ventricle lies. Due to head rotation, the peak region can appear as a single peak, or a multiple peak region, if not compensated with respect to the MSP.

Based on this plot of the number of skull voxels as a function of the axial slice number, sub-step 31(a) identifies the axial limits of the VOI for the fourth ventricle. Specifically, in this plot, anatomical point landmarks are identified. The slice located at point P1 at the maximum value of the peak corresponds to the skull base with the maximum bone area. A typical example of an axial slice at this axial position is shown in FIG. 6(b). Point P3 approximates the base of the peak. A typical example of an axial slice at this axial position is shown in FIG. 6(d). P2 is a point corresponding to the middle slice between P1 and P3. A typical example of an axial slice at this axial position is shown in FIG. 6(c). P3 can be calculated in several ways: for instance, as the axial slice where the skull base peak crosses the average number of skull voxels calculated for all the slices from P1 to the slice corresponding to the maximum of the brain with a clot distribution (i.e. the dominant peak of the curve shown in FIG. 4). So, the average skull voxel line is derived from slice P1 to the AC-PC slice. The point where this line intersects the skull voxel distribution curve is called P3. P2 is then the slice in the middle position between P1 and P3. From experimentation we observe that the inferior horns of the lateral ventricles are part of the slice at this P3. in order to avoid exclusion of hemorrhagic regions in the inferior horns, sub-step 31a defines the upper limit of the region of interest (ROI) around the fourth ventricle as the position P2. The lower limit is taken as the lowest slice of the scan.

(ii) Sub-Step 32a: Brain-with-a-Clot Voxels in Sagittal and Coronal Slices

Next, the method identifies the sagittal and coronal extent of the fourth ventricle region. In order to achieve this, sub-step 31b uses coronal and sagittal slices of the brain scan, but only the portion of those slices which is in the skull base region (i.e. the part of the coronal and sagittal slices having an axial position which is at P3 and to its left as shown in FIG. 6(a)). This is motivated by the anatomical knowledge that the fourth ventricle: (i) is in the skull base region, located posteriorly (in the posterior fosse), (see FIG. 7(c) where the ventricle is labelled 13), (ii) is at the middle region of the sagittal slices, and (iii) in posterior coronal slices with the maximum number of brain-with-a-clot voxels.

Sub-step 31b finds this location in the following way. First its neglects the anterior portion of the each axial slice, for instance the anterior 50% of each axial slice. Second, it reframes the remaining portion of the brain scan as sagittal slices, and, for each sagittal position, plots the total number of brain-with-a-clot voxels. The result is shown in FIG. 7(a). Sub-step 31b then finds the center of the distribution. The sub-step 31b selects a sagittal range of positions which is at the centre of the distribution, and has an extent in the sagittal direction proportional to the maximum diameter of the fourth ventricle. For instance, the range may be those positions in the sagittal direction which are ±2 cm from the center of the distribution. This width is chosen to be larger than the maximum radius of the fourth ventricle. This range is shown by the lines 9, 10, approximately at sagittal slices 220 to 330.

Third, sub-step 31b reframes the remaining portion of the brain scan (i.e. the portion after the anterior portion of each axial slice has been neglected, as explained above) as coronal slices. For each coronal position it plots the total number of brain-with-a-clot voxels. The result is shown in FIG. 7(b). Sub-step 31b then find the maximum of the distribution, and selects a coronal range of positions in the coronal direction which includes this maximum, and has an extent in the coronal direction of ±2 cm. This width is chosen to be larger than the maximum radius of the fourth ventricle. This range is shown by the lines 11, 12, approximately at coronal slices 220 to 330.

The ROI for the fourth ventricle is then defined as a cuboid having an extent in the axial direction from the lowest axial slice to P2, an extent in the sagittal direction which is the sagittal range, and an extent in the coronal direction which is the coronal range. FIG. 7(c) shows as box 14 the edges of the ROI which appear in a certain axial slice.

In sub-step 32 thresholding is performed within the ROI. In sub-step 33, region growing operations are performed in it. In sub-step 34, contrast enhancement is performed. These three sub-steps are performed in the same way as corresponding sub-steps (sub-steps 42 to 44) in the processing of the third and lateral ventricles, which are explained in detail below.

### Steps 3 and 4 Extraction of Hematoma in the Third and Lateral Ventricles

Although anatomically the fourth ventricle is normally connected with the third ventricle by the aqueduct, in the embodiment the extraction of hematoma in the third and lateral ventricles is performed as separate steps 3 and 4. This is because the aqueduct may neither be discernible nor present in the patient-specific scan due to low spatial resolution, small size, partial volume effect, swelling that compresses the aqueduct, or pathology distorting the anatomy.

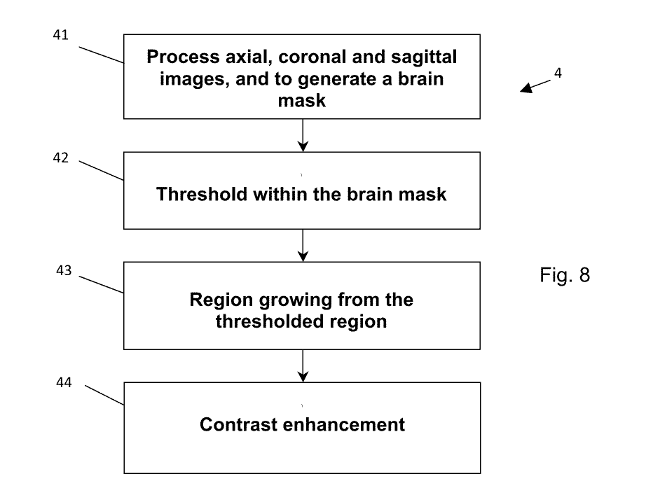

Each of steps 3 and 4 is performed in four sub-steps which are shown in FIG. 8: generation of a brain mask encompassing third and lateral ventricles (sub-step 41), hematoma distribution-based thresholding within the brain mask to produce seeds (sub-step 42), adaptive region growing (sub-step 43) and contrast enhancement (sub-step 44).

### Sub-Step 41 Generate a Brain Mask Around the Third and Lateral Ventricle Regions

We threshold the image using a lower threshold L and an upper threshold R to exclude all voxels but those in the range L to R. L and P are chosen so that this includes the voxels in the intensity range of WM and GM, since the ventricles are surrounded by WM and GM. For example, L may be chosen as the mean intensity of CSF, and R as the mean intensity of GM. Note that, typically the WM has intensities close to the mean intensity of WM, so lithe is excluded in this step. The effect of excluding voxels with an intensity above R, is to exclude hyperdense GM regions, which are close to the skull. In this way, we are able to exclude many artefacts due to the skull.

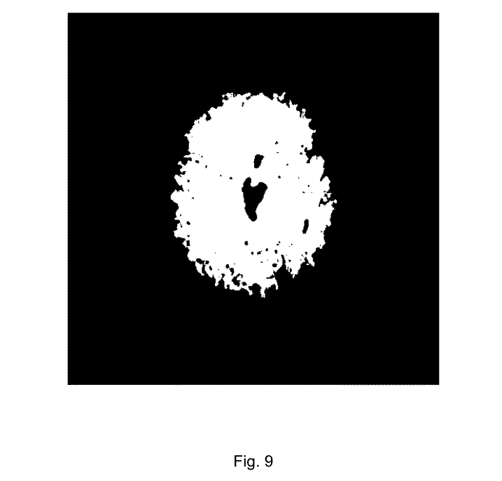

Smaller isolated regions are excluded from this thresholded image, for instance by eliminating regions with a sufficiently small area, such as regions which are <10% of the maximum largest connected region. In the experimental implementation of the embodiment this was done for each axial slice separately, but it may alternatively be done over the whole 3-D brain scan. The result is shown in FIG. 9. Alternatively, one or more of the largest connected components can be selected, and all other regions of the thresholded image excluded. (In some axial slices, such as the one shown in FIG. 9 there will only be one large connected component, but in superior slices and in the skull base region, the WM and GM regions may not be connected (in 2D) so multiple connected components should be retained.) Collectively, the component(s) selected in each axial slice form a single three-dimensional anatomical object.

The exterior boundary of the resulting image is then found, and used as the volume of interest for slices superior to that corresponding to point P2. The superior end of the lateral ventricles is found from the brain-with-a-clot distribution (shown in FIG. 4). The greyline 8 on the decreasing slope (FIG. 4) may be derived, for instance, as the axial position such that the number of brain-with-a-clot voxels is 50% of the maximum of the distribution (a lower percentage may be preferable in case of head tilt), and the axial position of the line 8 is taken as the superior limit of the lateral ventricles.

In summary, the brain mask for the lateral and third ventricles is such that: (i) its inferior limit is the slice P2; (ii) its superior limit is the slice corresponding to greyline 8 in FIG. 4 (although a higher slice can also be used); and (iii) it includes only the voxels with an intensity in the range L to R. Note that the choice of this mask around the fourth ventricle and lateral ventricles automatically excludes the skull.

Sub-Step 42: Seed Generation by Thresholding within the Brain Mask

The seed regions are determined using a narrow range(s) of intensity. The range(s) are chosen based on the intensity which gives the maximum of the distribution of the ground truth hematoma (shown in FIG. 2(b)) which corresponds to the number of days after the patient's haemorrhage on which the patient's brain scan was captured. This narrow range may be taken, for instance, ±5 HU, about the maximum. Alternatively, it may be taken as the range of HU such that the normalized number of voxels shown in FIG. 2(b) is 90% of the maximum value. The rationale of choosing the narrow range around the maximum of the distribution is that this is the most likely intensity range that would be part of the hemorrhage region on the day the patient's brain scan was captured.

This operation can be performed for the whole image. Alternatively or additionally, it may be performed for each row (i.e. line of voxels in the sagittal direction) and column (i.e. line of voxels in the coronal direction) of the image (and in the third dimension too).

This helps to separate the voxels which may have partial overlap with hemorrhage intensity distributions (as derived from the ground truth) in the tail regions of the distributions (i.e. voxels with intensities which are within the distributions of FIG. 2(b), but not within the peaks of those distributions). The limits of the rows and columns are determined from the lateral ventricle mask in FIG. 9. For example, the rows may be defined using the voxels which are part of the brain mask shown in FIG. 9.

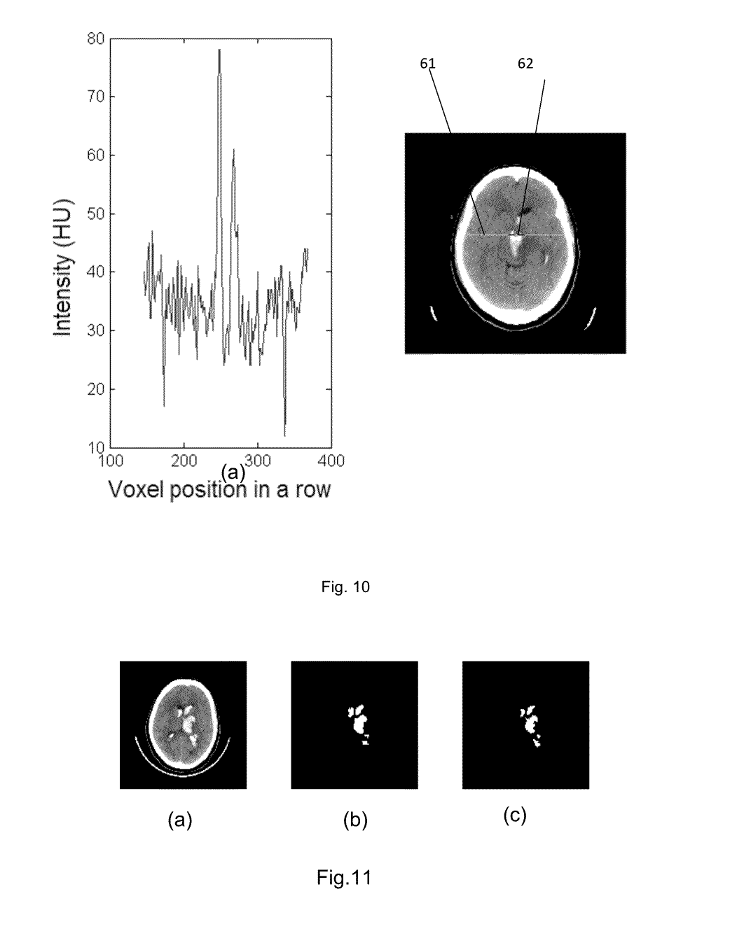

Let us, for example, explain how seeds can be created based on rows only. As discussed above, FIG. 9 is a thresholded image in the intensity range between the mean CSF to the mean GM, and this intensity range includes the WM. The ventricle region is inside this lateral ventricle mask. The seeds are generated by thresholding the original scan in the intensity range around the peak in FIG. 2(b) (e.g. 60 to 70 HU). Each row of the bright voxels shown in FIG. 9 can be treated individually for growing seeds. FIG. 10(a) plots the intensity (the vertical axis) of the brain scan versus the voxel position (the horizontal axis) for the row marked 61 in FIG. 10(b). The peaks with intensities in the narrow range around the maximum of the ground truth distribution of FIG. 2(b) are identified, and then, for each side of each such peak, it is determined where the peak intercepts with a certain pre-defined intensity value (which is not within the narrow range). If we call these two positions, the “intercept positions”, the grown seeds for this peak may be taken as the voxels between the two intercept positions. For example, we might use 40 HU as the pre-defined intensity value, in which case the grown seed would become the portion of the line 61 which is shown in FIG. 10(b) as the central black portion 62. In fact, FIG. 10(a) has two pears in this example, so line 62 has two parts, each part having ends where a corresponding one of the peaks intercepts with the line 40 HU.

It should be noted that the row analysis (as shown in FIG. 10) can be performed along with the column analysis, and optionally also in the third (axial) dimension. The analysis in any direction can be performed or any combination of directions can be used for analysis. The advantage of using row, column and third-dimension growth of seeds is that the result captures all the regions of the hematoma. If only row analysis is performed certain regions may be missed. Using more directions of growth will help to capture more parts of hematoma

The seeds generated from row, column and third-dimension analysis are illustrated in FIG. 11. FIG. 11(a) shows a certain axial slice. FIG. 11(b) shows the seeds in this axial slice which are generated as explained above by a row, column and third-dimension analysis. FIG. 11(c) shows ground truth.

Note that in the process above we exclude peaks which have high intensities, for instance, >85 HU. This eliminates any artefacts which are due to a catheter being located in the brain, or due to calcification and bones.

### Sub-Step 43: Region Growing

Region growing is then performed from the seed regions generated in the previous step, using a standard region growing algorithm performed in two- or three-dimensions with certain growing criteria. Region growing can be proceeded by image smoothing to reduce noise, for instance, by applying a median filter.

The growing criteria may be that the clot intensity is in a given range (for instance between 25-85 HU), and/or that the intensity corresponds to a percentage of the mean value of the ground truth population-based distribution (for instance, 10%). For instance, if the mean intensity of hematoma in a population is 57 HU, a growing criterion may that the intensity is in the range 57−5.7 HU to 57+5.7 HU.

### Sub-Step 44: Contrast Enhancement

The region grown may be further enhanced by using the contrast between the hematoma and the surrounding structures. “Contrast” refers to a difference between two regions, and can be calculated as an absolute difference between the mean values of the two regions, or by applying some edge detection operators. This contrast may be calculated in 1D, 2D or 3D for any region. For the specified contrast (e.g., 15 HU), the region grown border can be moved to correspond to this specified contrast. By varying the border between the region-grown hematoma and the surrounding tissues (i.e. extending the grown hematoma in a conservative way), the contrast can be increased to any given level (such as 15 HU or higher).

### Step 5: Post-Processing

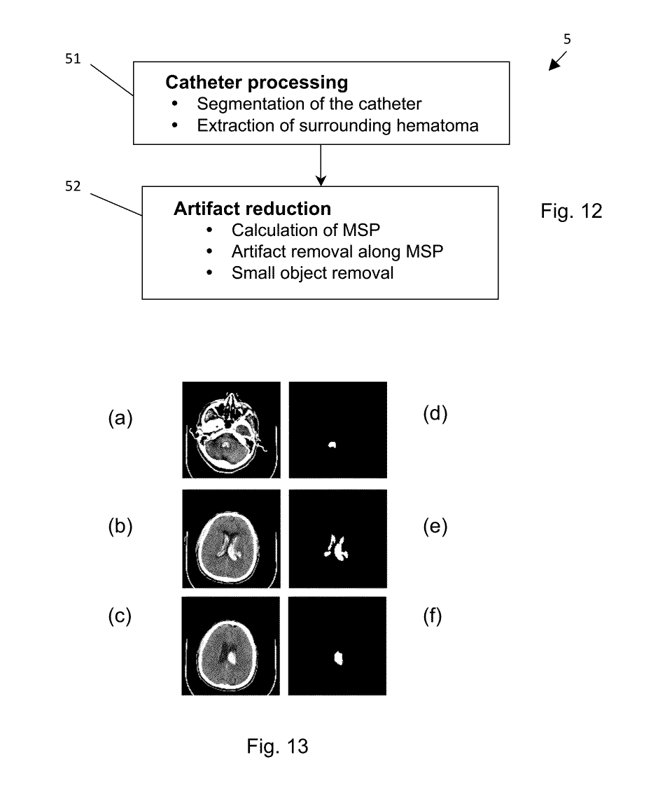

Post-processing, which has the flow diagram shown in FIG. 12 comprises catheter processing (sub-step 51) and artefact reduction (sub-step 52).

Sub-step 51 includes segmentation of the catheter, which may be done by thresholding using given lower and upper thresholds. There is then extraction of the surrounding hematoma. Sub-step 41 is appropriate if a catheter has been inserted into the brain, because this may cause secondary bleeding. To identify this situation, the actual size of the catheter is compared against the segmented region of the catheter along with potential hematoma.

Several artefacts are localized in the region of the inter-hemispheric fissure. They include calcification and hyperdensity due to falx cerebri. First in sub-step 52 the inter-hemispheric fissure is localized by extracting the mid-sagittal plane (MSP) (if this has not been done in an earlier step of the method, such as to correct for head tilt. The MSP can be extracted by any method; for instance, by employing our algorithm [6,7]. Then, hyperdense (and, particularly, elongated) regions on the MSP and its given vicinity are determined. These are regions which were extracted by the earlier steps of the embodiment, but which are false positives. The term “hyperdense” (which is common in the field of radiology) refers to regions with a relatively high HU (e.g. over a threshold). The hyperdense regions along the MSP are because of dura matter, while other hyperdense regions (which may also be removed in this step) are due to calcifications due to the partial volume effect (i.e. from neighbouring slices). The hyper-dense regions are removed if they do not form a part of hematoma extracted during processing of the ventricles.

Furthermore, noise may cause false positives. Small segmented regions, isolated in 3D (with no overlap with neighbouring slices) are eliminated. In other words, a part of sub-step 52 is to (i) identify small regions in axial slices of the hematoma identified in steps 2, 3 and 4, (ii) check whether neighbouring axial slices have similar regions in corresponding positions, and (iii) if not, remove them from the hematoma.

### Step 6: Combination of the Extracted Hematoma Regions

The hematoma regions calculated in the steps 3 (the fourth ventricle), 4 (the third and lateral ventricles) and 5 (the peri-catheter region) are merged to form the whole hematoma region for this patient-specific scan. Some sample results are illustrated in FIG. 13, where FIG. 13(a)-(c) show axial slices of the brain scan, and FIG. 13(d)-(f) show the corresponding hematoma detected by the method.

### Step 7: Calculation of the Hematoma Volume

The volume of whole hematoma region is calculated. This can be done by any of multiple methods. For instance, by adding the volumes of all voxels located within the segmented hematoma, where the parameters of the voxels are read from the DICOM header of the brain scan (assuming that the scan is in DICOM format).

### Variations of the Embodiment

Many variations of the method can be made within the scope of the method. For example, although in FIG. 1 the fourth ventricle is processed first, the ventricles may be precessed in any other order.

### REFERENCES

1. Poh L E, Gupta V, Johnson A, Kazmierski R, Nowinski W L: Automatic segmentation of ventricular CSF from ischemic stroke CT images. Neuroinformatics 2012; 10(2):159-72.
2. Gupta V, Nowinski W L: US 2012/0099779.
3. Gupta V, Ambrosius W, Qian G, Blazejewska A, Kazmierski R, Urbanik A, Nowinski W L. Automatic segmentation of Cerebrospinal Fluid, White and GreyMatter in Unenhanced Computed Tomography Images. Academic Radiology 2010, 17(11) 1350-1358.
4. Volkau I, Puspitsari F, Nowinski W L: A simple and fast method of 3D registration and statistical landmark localization for sparse multi-modal/time-series neuroimages based on cortex ellipse fitting. The Neuroradiology Journal 2012; 2(3): 63-76.
5. Volkau I. Bhanu Prakash K N, Ng U. Gupta V, Nowinski W L: Registering brain images by aligning reference ellipses. BIL/Z/04287 submitted 26 May 2006. BIL/P/04287/00/US, Provisional application No. US 60/816,876 filed on 28 Jun. 2006. SG patent 148531 granted 30 Sep. 2009.
6. Volkau I. Bhanu Prakash K N, Ng U. Gupta V, Nowinski W L: Localization of brain landmarks such as the anterior and posterior commissures based on geometrical fitting. BIL/Z/04234. BIL/P/04234/00/U.S. Provisional application No. 60/839,711 filed on 24 Aug. 2006. U.S. Pat. No. 8,045,775 granted on 25 Oct. 2011.
7. Bhanu Prakash K N. Volkov I, Nowinski W L: Locating a mid-sagittal plane. BIL/P/1866/US filed on 2 Apr. 2004. BIL/P/1666/2475/PCT. PCT/SG2005/000106 application filed on 1 Apr. 2005. WO 2005/096227 A1 published on 13 Oct. 2005. SG200604563-7 filed on 6 Jun. 2006. EP 05722353.9 file on 1 Apr. 2005. SG patent grant no. 200604563-7 granted on 30 Nov. 2007. U.S. Pat. No. 7,822,456B2 granted on 26 Oct. 2010. www.freepatentsonline.com/y2007/0276219.html
8. Volkau I, Bhanu Prakash K. N, Anand A, Aziz A, Nowinski W L: Extraction of the midsagittal plane from morphological neuroimages using the Kullback-Leibler's measure. Medical Image Analysis 2006; 10(4868-874.

1. A method of analysing a three-dimensional brain scan of the brain of a patient who has suffered a hemorrhagic stroke, the brain scan comprising a plurality of voxels, the method comprising:
(i) using pre-defined data comprising pre-defined distribution data describing typical brain scan intensity distributions of hematoma, to define, for each of one or more pre-defined regions of the brain, respective one or more portions of the brain scan; and
(ii) using the distribution data to identify voxels of the brain scan in the one or more portions of the brain said which represent hematoma in the brain.

2. The method of claim 1 in which the pre-defined data further comprises at least one spatial template describing the layout of a brain, the method further comprising a step of registering the spatial template with the brain scan, and the registered spatial template being used in said definition of at least one of said portions of the brain scan.

3. The method of claim 2 in which the spatial template is a vascular template.

4. The method of claim 1 in which said regions of the brain include the fourth ventricle, the distribution data further includes data describing typical intensity for skull material, and the corresponding portion of the brain is a volume of interest having limits in the axial direction obtained by:
generating a plot, for a number of axial positions, of the number of voxels having an intensity consistent with the typical intensity for skull material, and
choosing the limits using the plot.

5. The method of claim 4, in which the distribution data further includes data defining an intensity range associated with voxels representing cerebrospinal fluid (CSF), grey matter (GM), white matter (WM) or hematoma:
determining, for each of a number of axial positions, the number of voxels in that axial position having an intensity within the intensity range,
generating a second plot of the number of those voxels for each axial position; and
setting said limits using data derived from said second plot.

6. The method of claim 4 in which the volume of interest has a position in the sagittal and coronal directions defined in a posterior portion of the brain scan, by:
seeking a location in the posterior portion of the brain scan having a maximal number of voxels having an intensity within the intensity range; and
generating the volume of interest including said location.

7. The method of claim 1 in which the step of using the distribution data to identify hematoma in the one of more volumes of interest comprises:
using the distribution data for hematoma to identify seed points;
using the seed points to grow regions in the volumes of interest.

8. The method of claim 7 further comprising performing contrast enhancement on the grown regions.

9. The method of claim 7 further including using the distribution data to form one or more of said portions of the brain scan as a brain mask, the seeds being generated within the brain mask.

10. The method of claim 7 in which the seed points are formed by, for each of multiple lines of the voxels,
identifying a candidate hematoma region within the line of voxels, using a first intensity range derived from the distribution data for hematoma, and
generating the seeds as voxels within the candidate hematoma region which meet an intensity criterion.

11. The method of claim 10 in which the first intensity range is derived using a most common intensity value of voxels representing hematoma, and the intensity criterion generates said seeds as voxels having an intensity in a broader range than the first intensity range.

12. The method of claim 1 further including a step of identifying voxels representing hematoma in a portion of the brain scan proximate a portion of the brain scan representing a catheter.

13. The method of claim 1 further comprising identifying a mid-sagittal plane (MSP) of the brain scan, and eliminating ones of said identified voxels which are proximate the mid-sagittal plane.

14. The method of claim 1 further comprising determining whether ones of the identified voxels meet a criterion for identification as artefacts, and if the determination is positive eliminating those identified voxels.

15. A method of treating a patient who has suffered a hemorrhagic stroke, t method comprising:
(i) capturing at least one three-dimensional brain scan of the brain of the patient comprising a plurality of voxels,
(ii) using anatomical data comprising pre-defined distribution data describing one or more typical brain scan intensity distributions of hematoma, to define, for each of one or more pre-defined regions of the brain, respective one or more portions of the brain scan;
(iii) using the distribution data to identify voxels of the brain scan in the one or more portions of the brain said which represent hematoma in the brain;
(iv) selecting a treatment based on the identified voxels; and
(v) applying said treatment to the patient.

16. A computer system for analysing a three-dimensional brain scan of the brain of a patient who has suffered a hemorrhagic stroke, the brain scan comprising a plurality of voxels, the computer system comprising a processor and a data storage device storing computer instructions operative, when performed by the processor, to cause the processor to perform the steps of:
(i) using pre-defined data comprising pre-defined distribution data describing one or more typical brain scan intensity distributions of hematoma, to define, for each of one or more pre-defined regions of the brain, respective one or more portions of the brain scan; and
(ii) using the distribution data to identify voxels of the brain scan in the one or more portions of the brain said which represent hematoma in the brain.
